(19) United States
(12) Patent Application Publication
(10) Pub. No.: US 2010/0068596 A1
(43) Pub. Date: Mar. 18, 2010

(54) Direct methanol fuel cell system and portable electronic device

(75) Inventors: Mitsuru Nozue, Tokyo (JP); Koichi Mori, Tokyo (JP); Minoru Yagi, Tokyo (JP); Tetsuo Motohashi, Tokyo (JP); Hiroshi Obuse, Tokyo (JP)

Correspondence Address: POSZ LAW GROUP, PLC, 12040 SOUTH LAKES DRIVE, SUITE 101, RESTON, VA, 20191, US

(73) Assignee: KURITA WATER INDUSTRIES LTD., Tokyo (JP)

(21) Appl. No.: 12/311,704

(22) PCT Filed: Oct. 9, 2007
(86) PCT No.: PCT/JP2007/069689

§ 371 Date: Dec. 3, 2009

(30) Foreign Application Priority Data
Oct. 11, 2006 (JP) 2006-278166
Oct. 11, 2006 (JP) 2006-278167
Oct. 11, 2006 (JP) 2006-278168
Oct. 11, 2006 (JP) 2006-278169

(51) Int. Cl. H01M 2/00

(52) U.S. Cl. 429/34

(57) ABSTRACT

A direct methanol fuel cell system comprises a fuel storage portion that stores solid-state methanol resulting from making methanol into a solid state, a fuel cell, and carrier gas circulation means. The fuel storage portion is provided with a carrier gas supply path communicating with the carrier gas circulation means and a fuel gas flow path 4 communicating with a fuel electrode side of the fuel cell, while the fuel cell is provided with a circulation flow path communicating with the carrier gas circulation means. When a carrier gas is supplied by the carrier gas circulation means into the fuel storage portion via the carrier gas supply path, a fuel gas is supplied to a fuel electrode and is refluxed thereafter towards the carrier gas circulation means. The resulting direct methanol fuel cell system uses extremely safe solid-state methanol in a fuel cartridge.

### TECHNICAL FIELD

The present invention relates to a direct methanol fuel cell system using solid-state methanol as a fuel, and more particularly to a direct methanol fuel cell system suitable for small portable electronic devices.

### BACKGROUND ART

Solid polymer electrolyte fuel cells are devices in which a fuel electrode (anode) and an oxidant electrode (cathode) are respectively bonded to both faces of a solid electrolyte membrane such as a membrane of perfluorosulfonic acid or the like, as the electrolyte, and wherein power is generated through an electrochemical reaction sustained by supplying hydrogen or methanol to the anode, and oxygen to the cathode. Among such fuel cells, solid polymer electrolyte fuel cells using methanol as a fuel, called “direct methanol fuel cells (DMFC)”, generate power in accordance with the following reactions.

Anode: CH₃OH+H₂O→6H⁺+CO₂+6e⁻ [1]

Cathode: 3/2O₂+6H⁺+6e⁻→3H₂O [2]

To cause these reactions, the both electrodes are made of a mixture of a solid polymer electrolyte with carbon microparticles that support a catalytic substance.

In such a direct methanol fuel cell, the methanol supplied to the anode passes through pores in the electrode and reaches the catalyst. The catalyst causes the methanol to decompose and generate electrons and hydrogen ions, in accordance with the reaction formula [1] above. The hydrogen ions pass through the electrolyte of the anode and the solid electrolyte membrane interposed between the two electrodes, and reach the cathode, where they react with oxygen supplied to the cathode, and the electrons flowing through an external circuit, to generate water, in accordance with the reaction formula [2] above. The electrons released from the methanol pass through the catalyst carrier in the anode and are led to an external circuit, through which they flow into the cathode. As a result, power can be extracted at the external circuit on account of the flow of electrons from the anode to the cathode.

Direct methanol fuel cells using methanol as a fuel are useful as small power sources for portable electronic devices, thanks to their low operating temperature and the fact that they require no major auxiliary equipment, among other advantages. Efforts to develop direct methanol fuel cells as next-generation power sources for laptops, cell phones and the like have intensified in recent years.

The methanol used as a fuel, however, is a liquid, and hence prone to leaking. The flammability and toxicity of methanol itself are also grounds for concern. Coming up with ways of using methanol safely has thus become a challenge. As described above, carbon dioxide gas is generated at the fuel electrode when liquid methanol is supplied to the fuel electrode of a fuel cell. However, carbon dioxide gas diffuses poorly out of liquid methanol. This is problematic in that the carbon dioxide gas contributes to inhibiting the reaction at the fuel electrode, which may result in a drop in output. Limitations on the orientation of the fuel cell, as required for maintaining contact between a liquid and the fuel electrode, constitute another problem.

Further demerits of using a liquid fuel include, for instance, impairment fuel cell performance when impurities dissolved in the liquid fuel are supplied to the fuel cell, and the phenomenon of crossover, whereby methanol, as the liquid fuel component, permeates through the electrolyte membrane of the fuel cell and gets to the air electrode.

To address the issue of methanol safety, among others, the present applicants have proposed therefore various “solid-state methanol fuels” in which methanol is made into a solid state through formation of a molecular compound, to reduce the likelihood of fuel leaking while substantially reducing the flammability of the fuel (Patent documents 1 to 3). When the solid-state methanol comes into contact with water, the methanol in the solid is released into the water. The resulting methanol aqueous solution can also be used as the fuel of a direct methanol fuel cell.

Patent document 1: JP 2006-040629 A

Patent document 2: JP 2005-325254 A

Patent document 3: International Patent Publication No. 2005/062410

### DISCLOSURE OF THE INVENTION

### Problem to be Solved by the Invention

In the usage methods proposed in Patent documents 1 to 3, however, methanol is extracted by bringing solid-state methanol into contact with water, to generate a methanol aqueous solution that is supplied to a fuel cell. The fuel cell system in this approach suffers therefore from the same problems of leakage, crossover and so forth of the methanol aqueous solution, as in the case of liquid fuels. This water-supply scheme, moreover, requires some water supply means such as a water tank, pump or the like. A simpler device structure requiring no such water supply means is however preferable for use in a portable electronic device or the like. A need existed therefore for a direct methanol fuel cell in which methanol is supplied as a gas.

Meanwhile, low output is another problem of direct methanol fuel cells. At present, electronic devices do not operate relying on a direct methanol fuel cell alone, and the mainstream mode of operation involves a hybrid approach where a direct methanol fuel cell is combined with a rechargeable secondary battery. This hybrid approach, however, must still deliver a performance such that the secondary battery is charged stably by a direct methanol fuel cell operating at optimum efficiency.

A demand exists thus for direct methanol fuel cells in which methanol is supplied by being extracted, through vaporization, from solid-state methanol. However, water, which is required in an amount equimolar to the amount of methanol, tends to be insufficient in the anode in such methanol supply methods. A direct methanol fuel cell capable of continuous power generation with good efficiency would be thus desirable.

To realize the above-described performance, methanol must be supplied in such a manner that the direct methanol fuel cell can operate at optimum efficiency, i.e. the methanol supply rate must be adequately preserved. However, optimizing the methanol release rate has proved very difficult.

In the light of the above, it is an object of the present invention to provide a direct methanol fuel cell system that uses extremely safe solid-state methanol in a fuel cartridge, and supplies methanol as a gas at an adjustable methanol supply rate in the system in which the problems of liquid leakage and crossover that occur when a liquid fuel is used are solved. Another object of the present invention is to provide a portable electronic device using that direct methanol fuel cell system.

### Means for Solving the Problem

In order to solve the above problems, the present invention provides a direct methanol fuel cell system comprising a fuel storage portion that stores solid-state methanol resulting from making methanol into a solid state; a fuel cell; and carrier gas circulation means, wherein the fuel storage portion is provided with a carrier gas supply path communicating with the carrier gas circulation means and a fuel gas flow path communicating with a fuel electrode side of the fuel cell, the fuel cell is provided with a circulation flow path communicating with the fuel electrode side and communicating with the carrier gas circulation means, and when a carrier gas is supplied by the carrier gas circulation means into the fuel storage portion via the carrier gas supply path, a fuel gas comprising methanol vaporized from the solid-state methanol is supplied to a fuel electrode of the fuel cell and is refluxed thereafter towards the carrier gas circulation means through the circulation flow path (Invention 1).

In the above invention (Invention 1), methanol is loosely bounded by intermolecular forces, such as inclusion phenomena, inside the material of the solid-state methanol, and hence methanol vaporizes not abruptly, but gradually, when carrier gas is supplied to the fuel storage portion by the carrier gas circulation means such as a pump or the like. The fuel gas comprising the vaporized methanol is supplied to the fuel electrode of the fuel cell, where the vaporized methanol is decomposed on the catalyst of the fuel electrode and power is generated as a result. To generate power in the fuel cell, water must be supplied to the fuel electrode in an amount equimolar to the amount of methanol. At the start of power generation, however, the reaction proceeds using the water originally held in the electrolyte membrane. As the reaction progresses, the water generated in the reaction undergoes reverse osmosis at the electrolyte membrane and is supplied to the fuel electrode. Power generation can take place therefore without a supply of water.

Power generation is sustained by replenishing methanol at the fuel electrode through continued supply of carrier gas, while excess methanol is re-used by being refluxed towards the carrier gas circulation means via the circulation flow path. Thus, excess methanol is not supplied to the fuel electrode, and hence the direct methanol fuel cell system is free of the problems of, for instance, crossover and liquid leakage. Moreover, the carrier gas is re-used through circulation, and thus the methanol contained in the solid-state methanol can be effectively used without the need for providing separately a gas cylinder or the like.

In the above invention (Invention 1), controllable air introduction means may be provided in the carrier gas supply path, the fuel gas flow path or the circulation flow path (Invention 2), or a film may be formed on the surface of the solid-state methanol (Invention 3).

In the above inventions (Inventions 2 and 3), methanol is loosely bounded by intermolecular forces, such as inclusion phenomena, inside the material of the solid-state methanol, and hence methanol vaporizes not abruptly, but gradually, when carrier gas is supplied to the fuel storage portion by the carrier gas circulation means such as a pump or the like. The fuel gas comprising the vaporized methanol is supplied to the fuel electrode of the fuel cell, where the vaporized methanol is decomposed on the catalyst of the fuel electrode and power is generated as a result. Moreover, in film-coated solid-state methanol, methanol vaporizes gradually at a rate of vaporization determined by the characteristics of the film. The fuel gas comprising the vaporized methanol is supplied to the fuel electrode of the fuel cell, where the vaporized methanol is decomposed on the catalyst of the fuel electrode and power is generated as a result.

Power generation is sustained by replenishing methanol at the fuel electrode through continued supply of carrier gas, while excess methanol is re-used by being refluxed towards the carrier gas circulation means via the circulation flow path. Thus, excess methanol is not supplied to the fuel electrode, and hence the direct methanol fuel cell system is free of the problems of, for instance, crossover and liquid leakage. Moreover, the carrier gas is re-used through circulation, and thus the methanol contained in the solid-state methanol can be effectively used without the need for providing separately a gas cylinder or the like.

Air is mixed into the carrier gas or the fuel gas by providing controllable air introduction means in the carrier gas supply path, the fuel gas flow path or the circulation flow path, and by continuously or intermittently introducing small amounts of air, or introducing air when water is insufficient, by way of the air introduction means. The oxygen contained in this air oxidizes the methanol, yielding water that is supplied to the fuel electrode. It becomes possible thereby to supply the water required for wetting the electrolyte and for taking part in the reaction at the fuel electrode even when no liquid water is present inside the system.

Also, the present invention provides a fuel cell system comprising a fuel storage portion that stores solid-state methanol resulting from making methanol into a solid state; a fuel cell; and carrier gas supply means, wherein the fuel storage portion is provided with a carrier gas supply path communicating with the carrier gas supply means and a fuel gas flow path communicating with a fuel electrode side of the fuel cell, the fuel cell is provided with an exhaust gas path communicating with the fuel electrode side, and when a carrier gas is supplied to the fuel storage portion, a fuel gas comprising methanol vaporized from the solid-state methanol is supplied to a fuel electrode of the fuel cell, and is discharged thereafter through the exhaust gas path (Invention 4).

In the above invention (Invention 4), methanol is loosely bounded by intermolecular forces, such as inclusion phenomena, inside the material of the solid-state methanol, and hence methanol vaporizes not abruptly, but gradually, when carrier gas is supplied to the fuel storage portion by a blowing device such as a gas cylinder, a pump, a blower or the like. The fuel gas comprising the vaporized methanol is supplied to the fuel electrode of the fuel cell, where the vaporized methanol is decomposed on the catalyst of the fuel electrode and power is generated as a result. To generate power in the fuel cell, water must be supplied to the fuel electrode in an amount equimolar to the amount of methanol. At the start of power generation, however, the reaction proceeds using the water originally held in the electrolyte membrane. As the reaction progresses, the water generated in the reaction undergoes reverse osmosis at the electrolyte membrane and is supplied to the fuel electrode. Power generation can take place therefore without a supply of water.

Power generation is sustained by replenishing methanol at the fuel electrode through continued supply of carrier gas, while excess methanol is discharged through the exhaust gas path. Thus, excess methanol is not supplied to the fuel electrode, and hence the direct methanol fuel cell system is free of the problems of, for instance, crossover and liquid leakage.

Also, the present invention provides a fuel cell system comprising a fuel storage portion that stores solid-state methanol resulting from making methanol into a solid state; a fuel cell; and fuel gas supply means for supplying, to the fuel cell, a fuel gas comprising methanol vaporized from the solid-state methanol as a result of flow of a carrier gas, wherein the fuel gas supply means is provided with controllable air introduction means (Invention 5).

In the above invention (Invention 5), methanol is loosely bounded by intermolecular forces, such as inclusion phenomena, inside the material of the solid-state methanol, and hence methanol vaporizes not abruptly, but gradually, when air is supplied by the fuel gas supply means to the solid-state methanol in the fuel storage portion. The fuel gas comprising the vaporized methanol is supplied to the fuel electrode of the fuel cell, where the vaporized methanol is decomposed on the catalyst of the fuel electrode and power is generated as a result.

To generate power in the fuel cell, water must be supplied to the fuel electrode in an amount equimolar to the amount of methanol. At the start of power generation, however, the reaction proceeds using the water originally held in the electrolyte membrane. As the reaction progresses, the water generated in the reaction undergoes reverse osmosis at the electrolyte membrane and is supplied to the fuel electrode. Power generation can take place therefore without a supply of water. Power generation is sustained by replenishing methanol at the fuel electrode through continued supply of carrier gas.

Although methanol and water react in equimolar amounts at the fuel electrode of the fuel cell, research by the present inventors has revealed, however, that when the amount of water consumed is substantial, i.e. when the output of the fuel cell is increased, continued operation in that state renders insufficient the amount of water that is supplied to the fuel electrode in the form of air moisture or as the water from the air electrode that undergoes reverse osmosis at the electrolyte membrane. Over time, this water insufficiency may cause a decrease in output that is believed to arise not only from the failed supply of the water necessary for the reaction, when water becomes insufficient at the fuel electrode, but also from a lowered electric conductivity of the electrolyte membrane.

In the present invention (Invention 5), therefore, air is mixed into the carrier gas or the fuel gas by providing controllable air introduction means in the fuel gas supply means, and by continuously or intermittently introducing small amounts of air, or introducing air when water is insufficient, by way of the air introduction means. The oxygen contained in this air oxidizes the methanol, yielding water that flows along with the fuel gas into the fuel electrode. It becomes possible thereby to supply the water required for wetting the electrolyte and for taking part in the reaction at the fuel electrode, so that power can be generated stably even when no liquid water is present inside the system.

In the above invention (Invention 5), preferably, the fuel gas supply means comprises carrier gas supply means; a carrier gas supply path, provided in the fuel storage portion and communicating with the carrier gas supply means; and a fuel gas flow path communicating with a fuel electrode side of the fuel cell, the fuel cell is provided with an exhaust gas path communicating with the fuel electrode side, the controllable air introduction means is provided in the carrier gas supply path or the fuel gas flow path, and when a carrier gas is supplied to the fuel storage portion, a fuel gas comprising methanol vaporized from the solid-state methanol is supplied to a fuel electrode of the fuel cell, and is discharged thereafter through the exhaust gas path (Invention 6).

In the above invention (Invention 6), methanol is loosely bounded by intermolecular forces, such as inclusion phenomena, inside the material of the solid-state methanol, and hence methanol vaporizes not abruptly, but gradually, when carrier gas is supplied to the fuel storage portion by a blowing device such as a gas cylinder, a pump, a blower or the like. The fuel gas comprising the vaporized methanol is supplied to the fuel electrode of the fuel cell, where the vaporized methanol is decomposed on the catalyst of the fuel electrode and power is generated as a result.

Power generation is sustained by replenishing methanol at the fuel electrode through continued supply of carrier gas, while excess methanol is discharged through the exhaust gas path. Thus, excess methanol is not supplied to the fuel electrode, and hence the direct methanol fuel cell system is free of the problems of, for instance, crossover and liquid leakage.

Moreover, air is mixed into the carrier gas or the fuel gas by providing controllable air introduction means in the carrier gas supply path or the fuel gas flow path, and by continuously or intermittently introducing small amounts of air, or introducing air when water is insufficient, by way of the air introduction means. The oxygen contained in this air oxidizes the methanol, yielding water that is supplied to the fuel electrode. It becomes possible thereby to supply the water required for wetting the electrolyte and for taking part in the reaction at the fuel electrode even when no liquid water is present inside the system.

Also, the present invention provides a direct methanol fuel cell system comprising a fuel storage portion that stores solid-state methanol resulting from making methanol into a solid state; a fuel cell; and fuel gas supply means for supplying, to the fuel cell, a fuel gas comprising methanol vaporized from the solid-state methanol as a result of flow of a carrier gas, wherein a film is formed on the surface of the solid-state methanol (Invention 7).

In the above invention (Invention 7), methanol is loosely bounded by intermolecular forces, such as inclusion phenomena, inside the material of the solid-state methanol having a film formed thereon, and hence methanol vaporizes not abruptly, but gradually, at a rate of vaporization determined by the characteristics of the film, when air is supplied by the fuel gas supply means to the solid-state methanol in the fuel storage portion. The fuel gas comprising the vaporized methanol is supplied to the fuel electrode of the fuel cell, where the vaporized methanol is decomposed on the catalyst of the fuel electrode and power is generated as a result.

To generate power in the fuel cell, water must be supplied to the fuel electrode in an amount identical to the amount of methanol. At the start of power generation, however, the reaction proceeds using the water originally held in the electrolyte membrane. As the reaction progresses, the water generated in the reaction undergoes reverse osmosis at the electrolyte membrane and is supplied to the fuel electrode. Power generation can take place therefore without a supply of water. Power generation is sustained by replenishing methanol at the fuel electrode through continued supply of carrier gas.

The rate of vaporization of the methanol out of this solid-state methanol having a film formed thereon can be controlled by modifying the type and/or thickness of the film that is formed on the surface of the solid-state methanol. The supply conditions of methanol into the fuel cell can be optimally controlled thereby.

Specifically, the rate of vaporization of the methanol becomes slower the thicker the formed film is. In addition, the rate of vaporization of methanol can be slowed down depending on the material that forms the film. The film may therefore be formed in such a manner so as to optimize the rate of vaporization of methanol, in accordance with, for instance, the usage environment and output considerations. The film must be readily soluble in methanol.

In the above invention (Invention 7), preferably, the fuel storage portion is provided with a carrier gas supply path communicating with the carrier gas supply means and a fuel gas flow path communicating with a fuel electrode side of the fuel cell, the fuel cell is provided with an exhaust gas path communicating with the fuel electrode side, and when a carrier gas is supplied to the fuel storage portion, a fuel gas comprising methanol vaporized from the solid-state methanol having a film formed thereon is supplied to a fuel electrode of the fuel cell, and is discharged thereafter through the exhaust gas path (Invention 8).

In the above invention (Invention 8), methanol is loosely bounded by intermolecular forces, such as inclusion phenomena, inside the material of the solid-state methanol having a film formed thereon (hereafter, film-coated solid-state methanol), and hence methanol vaporizes not abruptly, but gradually, at a rate of vaporization determined by the characteristics of the film, when carrier gas is supplied to the fuel storage portion by a blowing device such as a gas cylinder, a pump, a blower or the like. The fuel gas comprising the vaporized methanol is supplied to the fuel electrode of the fuel cell, where the vaporized methanol is decomposed on the catalyst of the fuel electrode and power is generated as a result.

Power generation is sustained by replenishing methanol at the fuel electrode through continued supply of carrier gas, while excess methanol is discharged through the exhaust gas path. Thus, excess methanol is not supplied to the fuel electrode, and hence the direct methanol fuel cell system is free of the problems of, for instance, crossover and liquid leakage.

In the above inventions (Inventions 4 to 8), blowing means (Invention 9) or a compressed gas cylinder (Invention 10) can be used as the carrier gas supply means. Also, a heating device and a substance that generates a gas when heated may be used as the carrier gas supply means (Invention 11). Various supply means can be used thus as the carrier gas supply means, depending on the specifics of the device in which the system is to be used.

In the above inventions (Inventions 1 to 11), preferably, the fuel storage portion is a detachable cartridge (Invention 12). In such an invention (Invention 12), the system can be used again, in a good state, by replacing the cartridge when the amount of methanol in the solid-state methanol decreases, when the concentration of methanol in the fuel gas decreases, or when the output of the fuel cell drops.

In the above inventions (Inventions 1 to 12), preferably, the carrier gas that is supplied to the fuel electrode of the fuel cell comprises substantially no oxygen (Invention 13). Such an invention (Invention 13) allows preventing generation of hazardous substances such as formaldehyde, formic acid and methyl formate, which result from the oxidation of methanol, and allows preventing generation of heat and depletion of methanol due to methanol oxidation.

In the above inventions (Inventions 1 to 13), the solid-state methanol can be obtained by turning a methanol aqueous solution into a solid state (Invention 14). In the above inventions (Inventions 1 to 13), the fuel storage portion may contain the solid-state methanol and a water-containing solid material (Invention 15). In the above inventions (Inventions 1 to 13), a water-replenishment container containing a water-containing solid material may be provided between the fuel storage portion and the fuel cell (Invention 16).

At the start of power generation, as described above, the reaction proceeds using the water originally held in the electrolyte membrane. As the reaction progresses, the water generated in the reaction undergoes reverse osmosis at the electrolyte membrane and is supplied to the fuel electrode. Power generation can take place therefore without a supply of water. However, when the amount of water consumed is substantial, i.e. when the output of the fuel cell is increased, continued operation in that state renders insufficient the amount of water that is supplied to the fuel electrode in the form of air moisture or as water from the air electrode and which undergoes reverse osmosis at the electrolyte membrane. Over time, this water insufficiency may cause a decrease in output that is believed to arise not only from the failed supply of the water necessary for the reaction when water becomes insufficient at the fuel electrode, but also from a lowered electric conductivity of the electrolyte membrane.

In the above inventions (Invention 14 to 16), both methanol and water are in a solid state, and hence the water necessary for electrolyte wetting and for the reaction can be supplied through vaporization of methanol and water, so that power can be generated stably even when no liquid water is present inside the system.

In the above inventions (Invention 1 to 16), preferably, the fuel gas flow path has a branched shape in the fuel electrode (Invention 17).

In liquid fuel feed-type direct methanol fuel cell systems, the separator that functions as the fuel flow path in the fuel electrode is ordinarily a single meandering flow path. When such a separator is used as a flow path of vaporized methanol gas, the concentration of methanol gas in the fuel gas decreases from the upstream side towards the downstream side of the separator, with an accompanying drop in electromotive force on account of Nernst loss.

In the above invention (Invention 17), therefore, the fuel gas flow path has a branched shape in the fuel electrode. This reduces the difference in concentration of methanol gas in the fuel gas, and allows reducing thereby drops in electromotive force.

Further, the present invention provides a portable electronic device (Invention 18) comprising the direct methanol fuel cell system of the above inventions (Inventions 1 to 17). The above invention (Invention 18) affords a compact portable electronic device of stable operation, by using a compact direct methanol fuel cell system capable of generating power with good efficiency and in which the problems of crossover, liquid leakage and the like are improved.

### ADVANTAGEOUS EFFECT OF THE INVENTION

The present invention succeeds in providing a direct methanol fuel cell system in which the problems of crossover, liquid leakage and the like are improved, in which the supply rate of methanol can be adjusted, and in which the problems of output drops and the like are solved, whereby the system can generate power with good efficiency. Moreover, the direct methanol fuel cell system does not require water supply means or the like, and hence the invention has also the effect of making the direct methanol fuel cell system more compact.

### BRIEF DESCRIPTION OF THE DRAWINGS

FIG. 1 is a flow diagram illustrating a direct methanol fuel cell system according to a first embodiment of the present invention;

FIG. 2 is a cross-sectional diagram illustrating a fuel cartridge in the direct methanol fuel cell system according to the first embodiment of the present invention;

FIG. 3 is a plan-view diagram illustrating schematically a first example of a fuel electrode and a separator in the direct methanol fuel cell system according to the first embodiment of the present invention;

FIG. 4 is a plan-view diagram illustrating schematically a second example of a fuel electrode and a separator in the direct methanol fuel cell system according to the first embodiment of the present invention;

FIG. 5 is a plan-view diagram illustrating schematically a third example of a fuel electrode and a separator in the direct methanol fuel cell system according to the first embodiment of the present invention;

FIG. 6 is a flow diagram illustrating a direct methanol fuel cell system according to a second embodiment of the present invention;

FIG. 7 is a flow diagram illustrating a direct methanol fuel cell system according to a fourth embodiment of the present invention;

FIG. 8 is a flow diagram illustrating a direct methanol fuel cell system according to a fifth embodiment of the present invention;

FIG. 9 is a graph illustrating the relationship between load current density and cell output density in direct methanol fuel cell systems of Example 1 and Comparative example 1; and

FIG. 10 is a graph illustrating the relationship between load current density and cell output density in direct methanol fuel cell systems of Example 8 and Comparative example 4.

### DESCRIPTION OF THE REFERENCE NUMERALS

1 . . . carrier gas source (carrier gas supply means)

2, 12 . . . carrier gas supply path

3 . . . solid-state methanol fuel cartridge (fuel storage portion)

4, 14 . . . fuel gas flow path

5, 15 . . . fuel cell

6, 16 . . . fuel electrode

7, 17 . . . solid polymer electrolyte membrane

8, 18 . . . air electrode

9 . . . exhaust gas path

10A, 10B . . . air pump (air introduction means)

100 . . . pump (carrier gas circulation means)

13 . . . solid-state methanol fuel cartridge (fuel storage portion)

19 . . . circulation flow path

20A, 20B, 20C . . . air pump (air introduction means)

S . . . solid-state methanol (film-coated solid-state methanol)

### BEST MODE FOR CARRYING OUT THE INVENTION

Direct methanol fuel cell systems according to embodiments of the present invention are explained in detail below with reference to accompanying drawings.

### First Embodiment

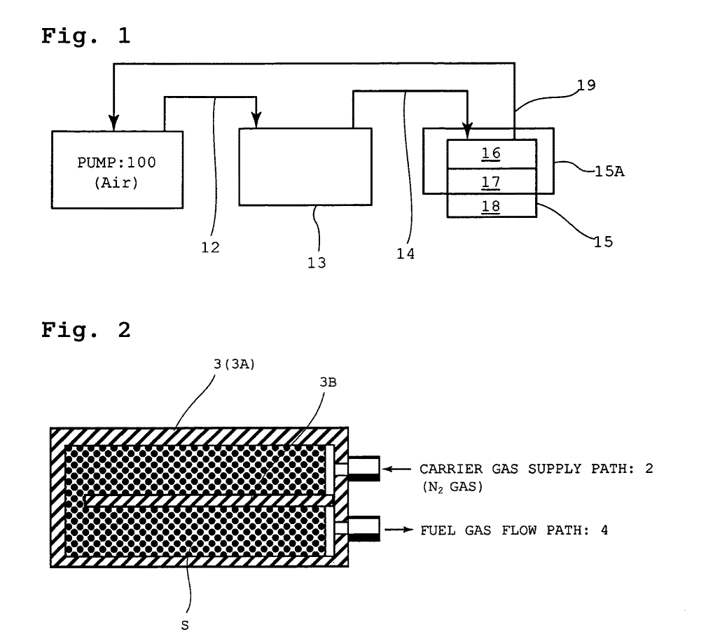

FIG. 1 is a flow diagram illustrating a direct methanol fuel cell system according to a first embodiment of the present invention, and FIG. 2 is a cross-sectional diagram illustrating a solid-state methanol storage container as a fuel container in FIG. 1.

As illustrated in FIGS. 1 and 2, the direct methanol fuel cell system according to the present embodiment comprises a pump 100, as carrier gas circulation means, for intake of ordinary air as the carrier gas; a solid-state methanol fuel cartridge 3 as a fuel storage portion of solid-state methanol; and a fuel cell 15. A carrier gas supply path 12 communicates the discharge side of the pump 100 with the solid-state methanol fuel cartridge 3, while a fuel gas flow path 14 communicates the solid-state methanol fuel cartridge 3 with the fuel cell 15.

In such a direct methanol fuel cell system, the solid-state methanol fuel cartridge 3 has a partition wall 3B such that a crooked flow path is formed inside a box-like casing 3A, as illustrated in FIG. 2. The interior of the solid-state methanol fuel cartridge 3 is packed with solid-state methanol S. One side (upper side in the figure) partitioned by the partition wall 3B is connected to the carrier gas supply path 12, while the other side (lower side in the figure) is connected to the fuel gas flow path 14. As a result, the carrier gas passes through the solid-state methanol fuel cartridge 3 while coming thoroughly into contact with the solid-state methanol S.

The fuel cell 15 comprises a fuel electrode 16, a solid polymer electrolyte membrane 17 and an air electrode 18. The fuel electrode 16 is sealed within a cover 15A that communicates with the fuel gas flow path 14 and with a circulation flow path 19 that is connected to the intake side of the pump 100. The air electrode 18 is open to the atmosphere. The circulation flow path 19 comprises a pressure-adjusting valve not shown.

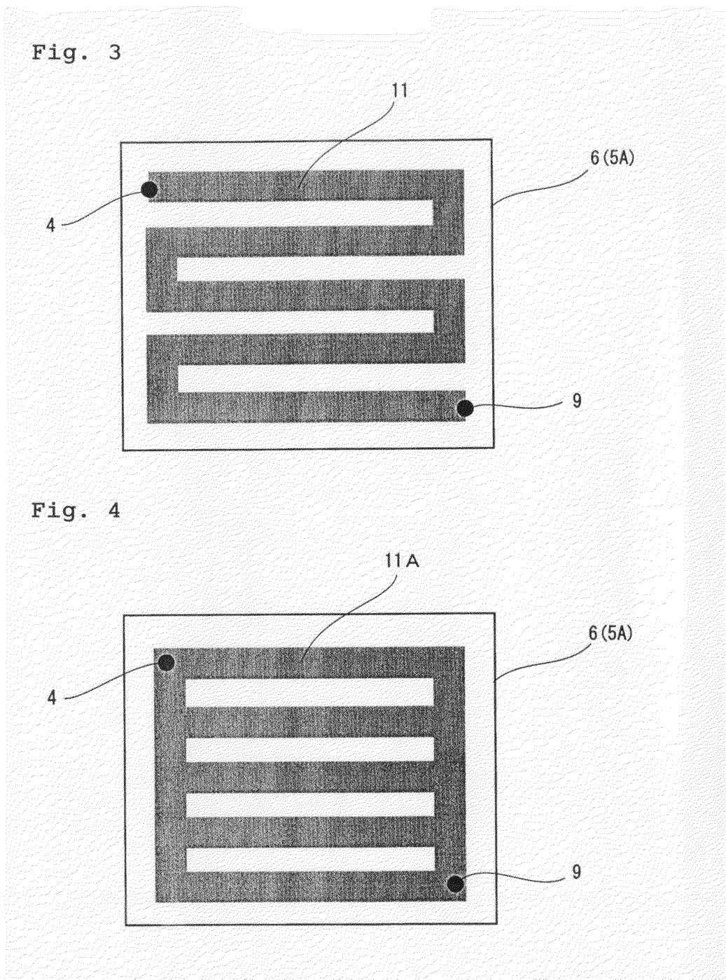

As illustrated in FIG. 3, a meandering separator 11 is built inside the cover 15A. One end of the separator 11 is connected to the fuel gas flow path 14 and the other end is connected to the circulation flow path 19, such that fuel gas passes along the separator 11.

In a direct methanol fuel cell system of the present embodiment such as the one described above, ordinary air is used as the carrier gas. However, the embodiment is not limited thereto, and nitrogen gas (N₂), an inert gas or the like may also be supplied as the carrier gas. When using air as the carrier gas, the oxygen in the air oxidizes the methanol, yielding as a result, in addition to water, also hazardous substances such as formaldehyde, formic acid and methyl formate. In the present embodiment, however, the carrier gas is recycled. Oxygen is therefore consumed immediately, and thus such oxidation reactions take place only initially. Therefore, the water generated initially is supplied to the fuel electrode, with such hazardous substances posing substantially no problem.

As the solid-state methanol S there can be used any substance that contains methanol and exhibits a solid state, for instance a molecular compound of methanol such as a methanol inclusion compound; solid-state methanol obtained through solidification of methanol together with a polymer or through gelling of methanol with dibenzylidene-D-sorbitol or the like; solid-state methanol in which methanol is held in a solid state through adsorption or the like onto an inorganic material such as magnesium aluminometasilicate or the like; or a coated product of any of the foregoing to adjust the vaporization temperature of methanol.

The molecular compound is a compound formed through bonding of two or more individually stable compounds by way of relatively weak interactions other than covalent bonds, typified by hydrogen bonds, Van der Waal's forces or the like. The molecular compound may be a hydrate, solvate, addition compound, inclusion compound or the like.

Such molecular compounds can be formed by way of a contact reaction of methanol with a compound that forms the molecular compound. Methanol can be made thereby into a solid-state compound, so that methanol can be stored stably and with a comparatively low weight. Particularly preferred among the above are methanol inclusion compounds resulting from a reaction between methanol and a host compound.

The solid-state methanol can be used in various forms and shapes, such as sheets, blocks (chunks), particles and the like. The solid-state methanol is preferably in the form of particles. When using particles as the solid-state methanol, the rate of vaporization of methanol can be increased by reducing the size of the particles. Moreover, a small particle size promotes the mobility of the generated methanol vapor.

In terms of handleability, packing ability and gas mobility, the particle size of the solid-state methanol ranges preferably from 1 μm to 10 mm, in particular from 100 μm to 5 mm.

Such a solid-state methanol comprises preferably 1 to 3 parts by weight of methanol taken up in 1 part by weight of base material.

In such a solid-state methanol there may be used not only 100% pure methanol made into a solid state, but also a methanol aqueous solution of desired concentration, resulting from adding water to methanol, and subsequently made into solid state.

In the present embodiment, the solid-state methanol fuel cartridge 3 may contain the solid-state methanol S and a water-containing solid material. The water-containing solid material may be capable of confining water to a degree such that no liquid water leaks out of the material. As a base material of the water-containing solid material there can be used, for instance, an inorganic porous material such as magnesium alminosilicate, an organic porous material, a fibrous material, a water-absorbing polymer material or the like. Although not limited thereto, specific examples include, for instance, inorganic porous materials such as silica-type or titania-type, activated carbon, porous glass, fibrous materials such as glass fibers, ordinary fabrics and paper, cellulose fibers, polyamide-based water-absorbing resins and the like. The water-containing solid material may be coated, to adjust thereby the vaporization temperature of water.

The water-containing solid material comprises preferably 1 to 3 parts by weight of water taken up in 1 part by weight of base material.

An explanation follows next on the operation of a direct methanol fuel cell system having the above configuration.

In FIG. 1, air is infused into the circulation flow path and is caused to circulate by the pump 100, whereupon the air passes through the carrier gas supply path 12 and flows into the solid-state methanol fuel cartridge 3.

The solid-state methanol S in the fuel cartridge 3 is methanol loosely bounded by intermolecular forces, such as inclusion phenomena, inside the material. As a result, methanol vaporizes gradually, not abruptly. The methanol molecules vaporizing gradually through the surface of the solid-state methanol S become mixed with air to yield a fuel gas that is supplied to the fuel electrode 16 of the fuel cell 15 via the fuel gas flow path 14. As illustrated in FIG. 3, the fuel gas passes through the separator 11 and reacts at the fuel electrode 16.

Power is generated as a result, in accordance with the reaction formulas below.

Anode: CH₃OH+H₂O→6H⁺+CO₂+6e⁻ [3]

Cathode: 3/2O₂+6H⁺+6e⁻→3H₂O [4]

The concentration of methanol in the vicinity of the fuel electrode 16 is fairly diluted, as compared with direct supply of liquid-state methanol (aqueous solution). Even in liquid-feed systems, however, methanol does not react completely at the fuel electrode 16, where only part of the methanol is decomposed, due to catalytic activity limitations. As the amount of excess methanol increases there increases also the amount of methanol that crosses over to the air electrode 18.

Therefore, a high concentration of methanol at the fuel electrode 16 is not necessarily advantageous. A concentration of methanol as achieved through vaporization out of solid-state methanol, via a carrier gas, affords an output comparable to that of liquid-feed systems.

Methanol decomposes at the fuel electrode 16 thereby becoming scantier. However, continuous supply of carrier gas by the pump 100 causes methanol gas to be supplied out of the solid-state methanol. This sustains the above-described power-generating reaction.

Reaction formula [3] shows that water is required in an amount equimolar to the amount of methanol. As described above, however, using air as the carrier gas causes water to be generated as a result of an initial oxidation reaction of the methanol. Hence, the reaction is initiated by the water resulting from this methanol oxidation and the water originally held in the solid polymer electrolyte membrane 17. As the reaction progresses, the water generated at the air electrode 18 in accordance with reaction formula [4] is supplied to the fuel electrode 16 through reverse osmosis at the solid polymer electrolyte membrane 17. This sustains the power-generating reaction. The fuel electrode 16 may contain some water beforehand to ensure reliable initial power generation.

Preferably, the above-described water-containing solid material is used concomitantly in cases of low moisture in air, which is the carrier gas, and/or when it is feared that the water generated at the cathode may be insufficient. As a result, moisture vaporized out of the water-containing solid material is supplied into the fuel electrode 16 together with the methanol and the carrier gas. The fuel electrode 16 may contain some water beforehand to ensure reliable initial power generation.

The reaction between methanol and water generates carbon dioxide in an amount equimolar to the amount of methanol. This carbon dioxide gas is caused to circulate by being refluxed towards the pump 100 via the circulation flow path 19. The methanol (gas) remaining at the fuel electrode 16 without reacting is caused to circulate likewise by being refluxed towards the pump 100 via the circulation flow path 19. As a result, the methanol contained in the solid-state methanol S does not diffuse into the outer environment. This has the effect of allowing using methanol effectively while prolonging the life of the fuel cartridge 3. Moreover, no separate carrier gas cylinder or the like need be prepared.

When a predetermined pressure is exceeded in the path as a result of, for instance, the carbon dioxide gas generated in the reaction at the anode, a suitable amount of carrier gas may be bled off through a pressure-adjusting valve (not shown) provided in the circulation flow path 19.

The methanol content in the solid-state methanol S decreases as the methanol contained therein is supplied to the fuel cell, for power generation. Therefore, power generation can be sustained by replacing the fuel cartridge 3 when power has been generated for a predetermined lapse of time, or when the output voltage falls below a predetermined level.

### Second Embodiment

The configuration of the direct methanol fuel cell system according to a second embodiment of the present invention is virtually identical to that of the first embodiment, but herein an air pump 20A, an air pump 20B or an air pump 20C, as air introduction means, is connected to any among a carrier gas supply path 12(1), a fuel gas flow path 14(2) or a circulation flow path 19(3). Elements identical to those of the first embodiment will be denoted with identical reference numerals, and a detailed explanation thereof will be omitted.

As illustrated in FIG. 6, the direct methanol fuel cell system according to the second embodiment comprises an air pump 20A, an air pump 20B or an air pump 20C, as air introduction means, connected to any among a carrier gas supply path 12(1), a fuel gas flow path 14(2) or a circulation flow path 19(3). The air pump 20A, 20B or 20C, which is connected to control means (not shown) provided with a sensor of the output of the fuel cell 15, stands normally still, but is controlled in such a way so as to supply a predetermined amount of air when the output of the fuel cell 15 drops below a predetermined value.

The air pumps 20A, 20B, 20C may be provided at any location, but preferably the air pumps 20A, 20B are provided in the carrier gas supply path 12 and the fuel gas flow path 14, since the concentration of methanol in the fuel gas may drop when the air pump 20C is provided in the circulation flow path 19.

An explanation follows next on the operation of the direct methanol fuel cell system of the second embodiment having the above configuration.

In FIG. 6 air is infused into the circulation flow path and is caused to circulate by the pump 100, whereupon the air passes through the carrier gas supply path 12 and flows into the solid-state methanol fuel cartridge 3.

The solid-state methanol S in the fuel cartridge 3 is methanol loosely bounded by intermolecular forces, such as inclusion phenomena, inside the material. As a result, methanol vaporizes gradually, not abruptly. The methanol molecules vaporizing gradually through the surface of the solid-state methanol S become mixed with air to yield a fuel gas that is supplied to the fuel electrode 16 of the fuel cell 15 via the fuel gas flow path 14.

Power is generated as a result, in accordance with the reaction formulas below.

Anode: CH₃OH+H₂O→6H⁺+CO₂+6e⁻ [5]

Cathode: 3/2O₂+6H⁺+6e⁻→3H₂O [6]

The concentration of methanol in the vicinity of the fuel electrode 16 is fairly diluted, as compared with direct supply of liquid-state methanol (aqueous solution). Even when supplied as a liquid, however, methanol does not react completely at the fuel electrode 16, where only part of the methanol is decomposed, due to catalytic activity limitations. As the amount of excess methanol increases there increases also the amount of methanol that crosses over to the air electrode 18.

Therefore, a high concentration of methanol at the fuel electrode 16 is not necessarily advantageous. A concentration of methanol as achieved through vaporization out of solid-state methanol, using N₂ gas as a carrier gas, affords an output comparable to that of liquid-feed systems.

Methanol decomposes at the fuel electrode 16 thereby becoming scantier. However, continuous supply of carrier gas by the pump 100 allows methanol gas to be supplied out of the solid-state methanol. This sustains the above-described power-generating reaction.

Reaction formula [5] shows that water is required in an amount equimolar to the amount of methanol. In the present embodiment, air is caused to circulate as a carrier gas, and thus water is generated at an initial stage in a methanol oxidation reaction. Hence, the reaction is initiated by the water resulting from this methanol oxidation and the water originally held in the solid polymer electrolyte membrane 17. However, the oxygen in the carrier gas becomes rapidly depleted accompanying circulation of the latter. As a result, water required in the anode reaction cannot go on being supplied out of the water generated at the cathode reaction alone. This is accompanied by a drop in the electric conductivity of the solid polymer electrolyte membrane 17, all of which may result in a drop in the output of the fuel cell 15.

Therefore, a control device (not shown) activates the air pumps 20A, 20B or 20C, so as to supply a predetermined amount of air when the output of the fuel cell 15 falls below a predetermined value.

The water generated through oxidation of methanol by oxygen in the air is supplied, together with the fuel gas, to the fuel electrode 16. It becomes possible thereby to supply the water required for wetting the solid polymer electrolyte membrane 17 and for taking part in the reaction at the fuel electrode 16 even when no liquid water is present inside the system. Drops in the output of the direct methanol fuel cell system caused by insufficient water are prevented as a result.

The fuel electrode 16 may contain some water beforehand to ensure reliable initial power generation.

The reaction of methanol and water yields carbon dioxide gas in an amount equimolar to the amount of methanol. The carbon dioxide gas is not released into the outer environment, but is caused to circulate by being refluxed towards the pump 100 via the circulation flow path 19. The methanol (gas) remaining at the fuel electrode 16 without reacting is caused to circulate likewise by being refluxed towards the pump 100 via the circulation flow path 19. As a result, the methanol contained in the solid-state methanol S does not diffuse into the outer environment. This has the effect of allowing using methanol effectively while prolonging the life of the fuel cartridge 3. Moreover, no separate carrier gas cylinder or the like need be prepared.

When a predetermined pressure is exceeded in the circulation path, as a result of, for instance, the carbon dioxide gas generated in the anode reaction and the air supplied by the air pumps 20A, 20B or 20C, a suitable amount of carrier gas may be bled off through a pressure-adjusting valve (not shown) provided in the circulation flow path 19.

The methanol content in the solid-state methanol decreases as the methanol contained therein is supplied to the fuel cell, for power generation. Therefore, power generation can be sustained by replacing the fuel cartridge 3 when power has been generated for a predetermined lapse of time, or when the output voltage falls below a predetermined level.

### Third Embodiment

The direct methanol fuel cell system according to the third embodiment of the present invention has the same configuration as that of the first embodiment, except that herein a coating film is formed on the surface of the solid-state methanol. Elements identical to those of the first embodiment will be denoted with identical reference numerals, and a detailed explanation thereof will be omitted.

In the direct methanol fuel cell system according to the third embodiment the interior of the solid-state methanol fuel cartridge 3 is packed with film-coated solid-state methanol S. The vaporization temperature of methanol can be regulated in such a film-coated solid-state methanol S, which is obtained by coating a film over the surface of solid-state methanol. This allows controlling the vaporization of the methanol held in a base material such as a porous material or a gel that is confined within the formed film.

Methods for forming a film on the surface of solid-state methanol include, for instance, bringing the solid-state methanol into contact with a coating agent.

Preferred examples of the coating agent include polymer materials having film-forming action, for instance, cellulosic materials such as methyl cellulose, ethyl cellulose, hydroxyethyl cellulose, hydroxypropyl cellulose, hydroxypropylmethyl cellulose, hydroxyethylmethyl cellulose, carboxymethyl cellulose, hydroxypropylmethyl cellulose acetate succinate and the like; water-soluble polymers (polyvinyl alcohol)-based materials such as polyvinyl alcohol (PVA); polymers soluble both in water and alcohols, such as polyvinyl pyrrolidone (PVP), and polyacrylic acid-based materials. The foregoing may be used singly or in arbitrary combinations of two or more.

Preferably used among the above coating agents are cellulose derivatives and/or PVA, in particular cellulose derivatives. Many cellulose derivatives are used, for instance, as binding materials for tablets and granules, matrix bases for sustained-release tablets, jellies or the like, in the medical field, and are also used in the food industry as thickener/gelling agents, film coating agents for health foods, capsule agents or shape-loss preventing agents in fries and pancakes. Cellulose derivatives boast thus proven safety for humans, and are hence appropriate in terms of safety, also in case of accidental ingestion by infants.

Methods for forming a film on the surface of the solid-state methanol by bringing into contact the solid-state methanol and a coating agent include, but not limited thereto, fluidized bed coating, coating by combined rolling and fluidizing, drum coating, pan coating and the like. Coating may involve film coating, sugar coating or the like, but preferably film coating, from the viewpoint of making the formed coating film as thin as possible, thereby increasing the methanol content in the solid-state methanol.

The blending amount of the coating agent ranges preferably from 0.0001 to 0.1 parts by weight relative to 1 part by weight of a solid-state methanol molding. The coating film can be effectively formed on the surface of the solid-state methanol molding, to a desired thickness, when the blending amount of coating agent falls within the above range.

Preferably, the film-coated solid-state methanol thus obtained comprises 1 to 3 parts by weight of methanol relative to 1 part by weight of base material. When the solid-state methanol is obtained by introducing water and methanol into a porous material, the solid-state methanol comprises preferably a total 1 to 3 parts by weight of methanol and water taken up in 1 part by weight of base material.

An explanation follows next on the operation of the direct methanol fuel cell system of the third embodiment having the above construction.

In FIG. 1, air is supplied by the pump 100, whereupon the air is infused into the solid-state methanol fuel cartridge 3 via the carrier gas supply path 12.

The solid-state methanol S in the fuel cartridge 3 is methanol loosely bounded by intermolecular forces, such as inclusion phenomena, inside the material. As a result, methanol vaporizes not abruptly but gradually, at a rate of vaporization determined by the characteristics of the coating film. The rate of vaporization of the methanol is adjusted to a desired value by appropriately setting beforehand the material and thickness of the coating film. The methanol molecules vaporizing gradually out of the surface of the film-coated solid-state methanol S become mixed with air to yield a fuel gas that is supplied to the fuel electrode 16 of the fuel cell 15 via the fuel gas flow path 14.

Power is generated as a result, in accordance with the reaction formulas below.

Anode: CH₃OH+H₂O→6H⁺+CO₂+6e⁻ [7]

Cathode: 3/2O₂+6H⁺+6e⁻→3H₂O [8]

The concentration of methanol in the vicinity of the fuel electrode 16 is fairly diluted, as compared with direct supply of liquid-state methanol (aqueous solution). Even when supplied as a liquid, methanol does not react completely at the fuel electrode 16, where only part of the methanol is decomposed, due to catalytic activity limitations. As the amount of excess methanol increases there increases also the amount of methanol that crosses over to the air electrode 18.

Therefore, a high concentration of methanol at the fuel electrode 16 is not necessarily advantageous. A concentration of methanol as achieved through vaporization out of solid-state methanol, using N₂ gas as a carrier gas, affords an output comparable to that of liquid-feed systems.

Methanol decomposes at the fuel electrode 16 thereby becoming scantier. However, continuous supply of carrier gas by the pump 100 allows methanol gas to be supplied out of the solid-state methanol. This sustains the above-described power-generating reaction.

Reaction formula [7] shows that water is required in an amount equimolar to the amount of methanol. In the present embodiment, air is caused to circulate as a carrier gas, and thus water is generated at an initial stage in a methanol oxidation reaction. Hence, the reaction is initiated by the water resulting from this methanol oxidation and the water originally held in the solid polymer electrolyte membrane 17.

The fuel electrode 16 may contain some water beforehand to ensure reliable initial power generation.

The reaction of methanol and water yields carbon dioxide gas in an amount equimolar to the amount of methanol. The carbon dioxide gas is caused to circulate by being refluxed towards the pump 100 via the circulation flow path 19. The methanol (gas) remaining at the fuel electrode 16 without reacting is caused to circulate likewise by being refluxed towards the pump 100 via the circulation flow path 19. As a result, the methanol contained in the film-coated solid-state methanol S does not diffuse into the outer environment. This has the effect of allowing using methanol effectively while prolonging the life of the fuel cartridge 3. Moreover, no separate carrier gas cylinder or the like need be prepared.

When a predetermined pressure is exceeded in the circulation path, as a result of, for instance, the carbon dioxide gas generated in the reaction at the anode, a suitable amount of carrier gas may be bled off through a pressure-adjusting valve (not shown) provided in the circulation flow path 19.

The methanol content in the film-coated solid-state methanol S decreases as the methanol contained therein is supplied to the fuel cell, for power generation. Therefore, power generation can be sustained by replacing the fuel cartridge 3 when power has been generated for a predetermined lapse of time, or when the output voltage falls below a predetermined level.

### Fourth Embodiment

A direct methanol fuel cell system according to a fourth embodiment of the present invention will be explained in detail below with reference to accompanying drawings.

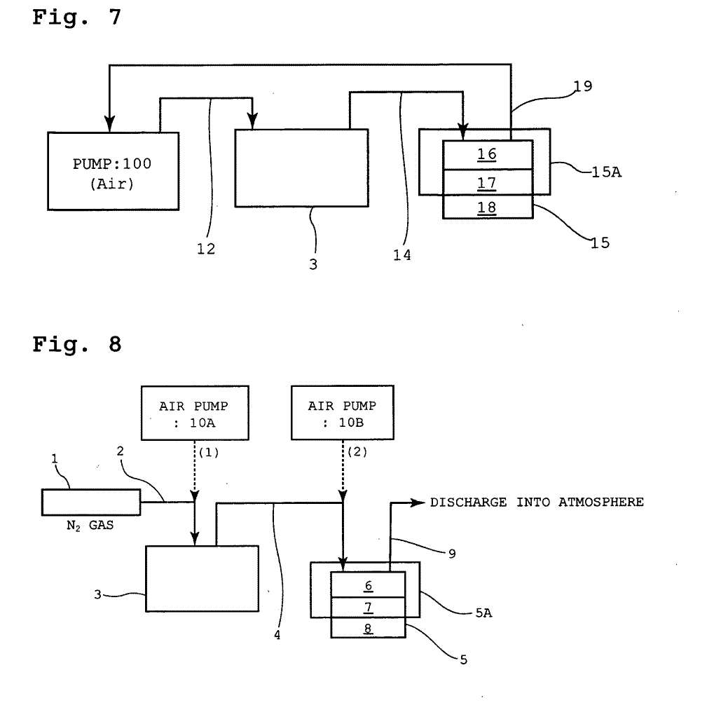

FIG. 7 is a flow diagram illustrating a direct methanol fuel cell system according to the fourth embodiment.

As illustrated in FIG. 7, the direct methanol fuel cell system according to the present embodiment comprises a carrier gas source 1 provided with a compressed gas cylinder of nitrogen gas (N₂), as carrier gas supply means, such that no oxygen is supplied to the fuel electrode; a solid-state methanol fuel cartridge 3 as a fuel storage portion of solid methanol; and a fuel cell 5. A carrier gas supply path 2 communicates the carrier gas source 1 with the solid-state methanol fuel cartridge 3, while a fuel gas flow path 4 communicates the solid-state methanol fuel cartridge 3 with the fuel cell 5.

In such a direct methanol fuel cell system, the solid-state methanol fuel cartridge 3 has a partition wall 3B such that a crooked flow path is formed inside a box-like casing 3A, as illustrated in FIG. 2. The interior of the solid-state methanol fuel cartridge 3 is packed with solid-state methanol S. One side (upper side in the figure) partitioned by the partition wall 3B is connected to the carrier gas supply path 2, while the other side (lower side in the figure) is connected to the fuel gas flow path 4. As a result, the carrier gas passes through the solid-state methanol fuel cartridge 3 while coming thoroughly into contact with the solid-state methanol S.

The fuel cell 5 comprises a fuel electrode 6, a solid polymer electrolyte membrane 7 and an air electrode 8. The fuel electrode 6 is sealed within a cover 5A that communicates with the fuel gas flow path 4 and with an exhaust gas path 9, while the air electrode 8 is open to the atmosphere.

As illustrated in FIG. 3, a meandering separator 11 is built inside the cover 5A. One end of the separator 11 is connected to the fuel gas flow path 4 and the other end is connected to the exhaust gas path 9, such that fuel gas passes along the separator 11.

In the direct methanol fuel cell system of the present embodiment such as the one described above, nitrogen gas (N₂) is used as the carrier gas. However, the embodiment is not limited thereto, and ordinary air may be supplied to the solid-state methanol fuel cartridge 3. Preferably, the carrier gas that is used contains substantially no oxygen, with a view to preventing generation of hazardous substances such as formaldehyde, formic acid and methyl formate, which result from the oxidation of methanol, and with a view to preventing generation of heat and depletion of methanol due to methanol oxidation. When air is supplied, therefore, it is preferable to provide for instance oxygen-removing means in the carrier gas supply path 2.

The same fuel cartridge as in the first embodiment can be used as the fuel cartridge 3, and also the same solid-state methanol as in the first embodiment can be used as the solid-state methanol S. As is the case in the first embodiment, the fuel cartridge 3 may contain the solid-state methanol S together with a water-containing solid material.

An explanation follows next on the operation of the fourth direct methanol fuel cell system having the above construction.

In FIG. 7, N₂ gas is supplied from the carrier gas source 1, whereupon the N₂ gas passes through the carrier gas supply path 2 and flows into the solid-state methanol fuel cartridge 3.

The solid-state methanol S in the fuel cartridge 3 is methanol loosely bounded by intermolecular forces, such as inclusion phenomena, inside the material. As a result, methanol vaporizes gradually, not abruptly. The methanol molecules vaporizing gradually through the surface of the solid-state methanol S become mixed with N₂ gas to yield a fuel gas that is supplied to the fuel electrode 6 of the fuel cell 5 via the fuel gas flow path 4. As illustrated in FIG. 3, the fuel gas passes through the separator 11 and reacts at the fuel electrode 6.

Power is generated as a result, in accordance with the reaction formulas below.

Anode: CH₃OH+H₂O→6H⁺+CO₂+6e^{-[}9]

Cathode: 3/2O₂+6H⁺+6e⁻→3H₂O [10]

The concentration of methanol in the vicinity of the fuel electrode 6 is fairly diluted, as compared with direct supply of liquid-state methanol (aqueous solution). Even when supplied as a liquid, methanol does not react completely at the fuel electrode 6, where only part of the methanol is decomposed, due to catalytic activity limitations. As the amount of excess methanol increases there increases also the amount of methanol that crosses over to the air electrode 8.

Therefore, a high concentration of methanol at the fuel electrode 6 is not necessarily advantageous. A concentration of methanol as achieved through vaporization out of solid-state methanol, using N₂ as a carrier gas, affords an output comparable to that of liquid-feed systems.

Methanol decomposes at the fuel electrode 16 thereby becoming scantier. However, continuous supply of N₂ gas from the carrier gas source 1 allows methanol gas to be supplied out of the solid-state methanol. This sustains the above-described power-generating reaction.

Reaction formula [9] shows that water is required in an amount equimolar to the amount of methanol. Preferably, the above-described water-containing solid material is used concomitantly when moisture in the carrier gas is low, and/or when it is feared that the water generated at the cathode may be insufficient. As a result, moisture vaporized out of the water-containing solid material is supplied into the fuel electrode 6 together with the methanol and the carrier gas. To ensure reliable early power generation, the fuel electrode 6 may contain some water beforehand.

The reaction of methanol and water yields carbon dioxide gas in an amount equimolar to the amount of methanol. The carbon dioxide gas is discharged into the outer environment via the exhaust gas path 9.

The methanol content in the solid-state methanol decreases as the methanol contained therein is supplied to the fuel electrode 6, for power generation. Therefore, power generation can be sustained by replacing the fuel cartridge 3 when power has been generated for a predetermined lapse of time, or when the output voltage falls below a predetermined level.

### Fifth Embodiment

The construction of the direct methanol fuel cell system according to a fifth embodiment of the present invention is virtually identical to that of the fourth embodiment, but herein an air pump 10A or an air pump 10B, as air introduction means, is connected to a carrier gas supply path 2(1) or a fuel gas flow path 4(2). Elements identical to those of the fourth embodiment will be denoted with identical reference numerals, and a detailed explanation thereof will be omitted.

As illustrated in FIG. 8, the direct methanol fuel cell system according to the fifth embodiment comprises an air pump 10A or air pump 10B, as air introduction means, connected to a carrier gas supply path 2(1) or a fuel gas flow path 4(2). The air pump 10A, 10B, which is connected to control means (not shown) provided with a sensor of the output of the fuel cell 5, stands normally still, but is controlled in such a way so as to supply a predetermined amount of air when the output of the fuel cell 5 drops below a predetermined value.

An explanation follows next on the operation of the direct methanol fuel cell system of the fifth embodiment having the above construction.

In FIG. 8, N₂ gas is supplied from the carrier gas source 1, whereupon the N₂ gas passes through the carrier gas supply path 2 and flows into the solid-state methanol fuel cartridge 3.

The solid-state methanol S in the fuel cartridge 3 is methanol loosely bounded by intermolecular forces, such as inclusion phenomena, inside the material. As a result, methanol vaporizes gradually, not abruptly. The methanol molecules vaporizing gradually through the surface of the solid-state methanol S become mixed with N₂ gas to yield a fuel gas that is supplied to the fuel electrode 6 of the fuel cell 5 via the fuel gas flow path 4.

Power is generated as a result, in accordance with the reaction formulas below.

Anode: CH₃OH+H₂O→6H⁺+CO₂+6e⁻ [11]

Cathode: 3/2O₂+6H⁺+6e⁻3H₂O [12]

The concentration of methanol in the vicinity of the fuel electrode 6 is fairly diluted, as compared with direct supply of liquid-state methanol (aqueous solution). Even when supplied as a liquid, methanol does not react completely at the fuel electrode 6, where only part of the methanol is decomposed, due to catalytic activity limitations. As the amount of excess methanol increases there increases also the amount of methanol that crosses over to the air electrode 8.

Therefore, a high concentration of methanol at the fuel electrode 6 is not necessarily advantageous. A concentration of methanol as achieved through vaporization out of solid-state methanol, using N₂ gas as a carrier gas, affords an output comparable to that of liquid-feed systems.

Continuous supply of N₂ gas from the carrier gas source 1 allows methanol gas to be supplied out of the solid-state methanol. This sustains the above-described power-generating reaction as methanol decomposes at the fuel electrode 6 thereby becoming scantier.

Reaction formula [11] shows that water is required in an amount equimolar to the amount of methanol. When moisture in the carrier gas is low, water required in the anode reaction cannot be supplied just out of the water generated at the cathode reaction alone. This is accompanied by a drop in the electric conductivity of the solid polymer electrolyte membrane 7, all of which may result in a drop in the output of the fuel cell 5.

Therefore, a controller (not shown) activates the air pump 10A or air pump 10B, so as to supply a predetermined amount of air when the output of the fuel cell 5 falls below a predetermined value.

The water generated through oxidation of methanol by oxygen in the air is supplied, together with the fuel gas, to the fuel electrode 6. It becomes possible thereby to supply the water required for wetting the MEA, and for taking part in the reaction at the fuel electrode 6 even when no liquid water is present inside the system. This allows preventing drops in the output of the DMFC caused by insufficient water.

The fuel electrode 6 may contain some water beforehand to ensure reliable initial power generation. The reaction of methanol and water yields carbon dioxide gas in an amount equimolar to the amount of methanol. The carbon dioxide gas is discharged into the outer environment via the exhaust gas path 9.

The methanol content in the solid-state methanol decreases as the methanol contained therein is supplied to the fuel cell, for power generation. Therefore, power generation can be sustained by replacing the fuel cartridge 3 when power has been generated for a predetermined lapse of time, or when the output voltage falls below a predetermined level.

### Sixth Embodiment

The construction of the direct methanol fuel cell system according to a sixth embodiment of the present invention is identical to that of the fourth embodiment, except that herein a coating film is formed on the surface of the solid-state methanol. Elements identical to those of the fourth embodiment will be denoted with identical reference numerals, and a detailed explanation thereof will be omitted.

In the sixth embodiment there can be used the same solid-state methanol fuel cartridge 3 and the same film-coated solid-state methanol as in the third embodiment.

An explanation follows next on the operation of the direct methanol fuel cell system of the sixth embodiment having the above construction.

In FIG. 7, N₂ gas is supplied from the carrier gas source 1, whereupon the N₂ gas passes through the carrier gas supply path 2 and flows into the solid-state methanol fuel cartridge 3.

The film-coated solid-state methanol S in the fuel cartridge 3 is methanol loosely bounded by intermolecular forces, such as inclusion phenomena, inside the material. As a result, methanol vaporizes not abruptly but gradually, at a rate of vaporization determined by the characteristics of the film. The rate of vaporization of the methanol is adjusted to a desired value by appropriately setting beforehand the material and thickness of the coating film. The methanol molecules vaporizing gradually out of the surface of the film-coated solid-state methanol S become mixed with N₂ gas to yield a fuel gas that is supplied to the fuel electrode 6 of the fuel cell 5 via the fuel gas flow path 4.

Power is generated as a result, in accordance with the reaction formulas below.

Anode: CH₃OH+H₂O→6H⁺+CO₂+6e^{-[}13]

Cathode: 3/2O₂+6H⁺+6e⁻→3H₂O [14]

The concentration of methanol in the vicinity of the fuel electrode 6 is fairly diluted, as compared with direct supply of liquid-state methanol (aqueous solution). Even when supplied as a liquid, methanol does not react completely at the fuel electrode 6, where only part of the methanol is decomposed, due to catalytic activity limitations. As the amount of excess methanol increases there increases also the amount of methanol that crosses over to the air electrode 8.

Therefore, a high concentration of methanol at the fuel electrode 6 is not necessarily advantageous. A concentration of methanol as achieved through vaporization out of solid-state methanol, using N₂ gas as a carrier gas, affords an output comparable to that of liquid-feed systems.

Continuous supply of N₂ gas from the carrier gas source 1 allows methanol gas to be supplied out of the film-coated solid-state methanol S, which sustains the above-described power-generating reaction as methanol decomposes at the fuel electrode 6 thereby becoming scantier.

The fuel electrode 6 may contain some water beforehand to ensure reliable initial power generation. The reaction of methanol and water yields carbon dioxide gas in an amount equimolar to the amount of methanol. The carbon dioxide gas is discharged into the outer environment via the exhaust gas path 9.

The methanol content in the film-coated solid-state methanol S decreases as the methanol contained therein is supplied to the fuel cell, for power generation. Therefore, power generation can be sustained by replacing the fuel cartridge 3 when power has been generated for a predetermined lapse of time, or when the output voltage falls below a predetermined level.

Reaction formula [13] shows that water is required in an amount equimolar to the amount of methanol. In the present embodiment, however, water is not an essential prerequisite. This is thought to be accounted for by the reasons below.

At the start of power generation, the reaction is initiated at the fuel electrode 6 by utilizing the water originally held at the solid polymer electrolyte membrane 7. As the reaction progresses, the water generated at the air electrode 8 in accordance with reaction formula [14] is supplied to the fuel electrode 6 through reverse osmosis at the solid polymer electrolyte membrane 7. To ensure reliable early power generation, the fuel electrode 6 may contain some water beforehand.

The present invention has been explained on the basis of embodiments. The invention, however, is not limited to these embodiments, and may be modified in numerous ways.

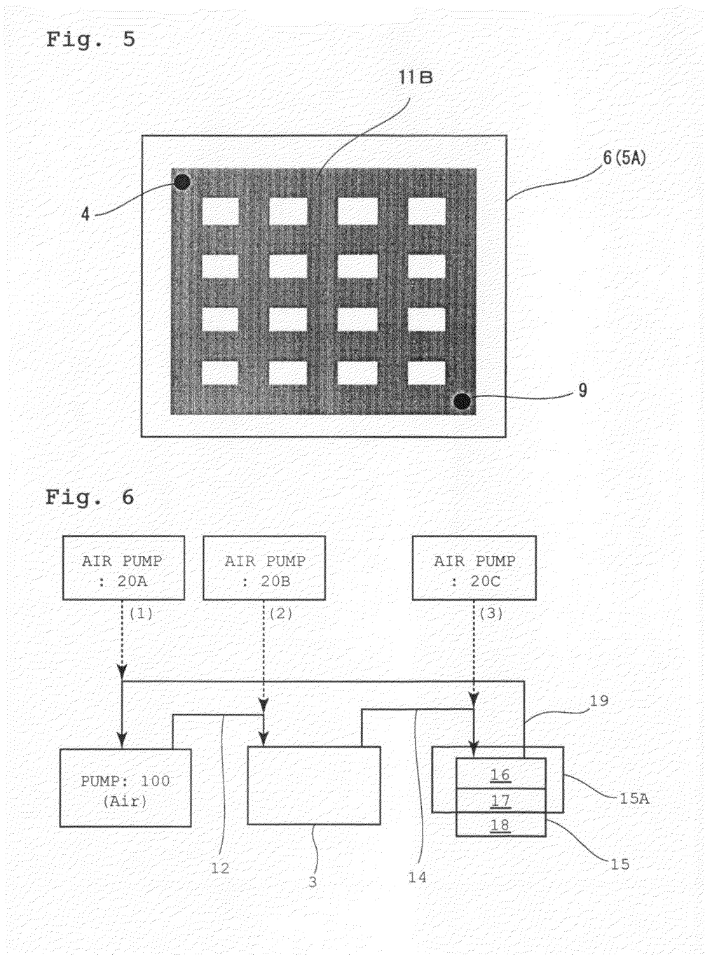

In the above-described embodiments, for instance, the separator 11 of the fuel electrode 6 had a meandering shape, as illustrated in FIG. 3. In such a separator 11, the concentration of methanol gas in the fuel gas decreases from the upstream side (fuel gas flow path 4) towards the downstream side (exhaust gas path 9) as it reacts at the fuel electrode 6, with an accompanying drop in electromotive force on account of Nernst loss. Therefore, it is preferable to reduce the difference in concentration of methanol gas in the fuel gas, between the upstream and downstream sides of the separator 11, to suppress the drop in electromotive force, for instance by branching the separator, i.e. by forming a parallel separators 11A, as illustrated in FIG. 4, or by forming a grid-like separator 11B, as illustrated in FIG. 5. The separator 11 is not limited to the above shapes, and may be branched in various other ways, for instance in a radially-extending configuration.

In the above-described embodiments, a compressed gas cylinder of nitrogen gas (N₂) was used as carrier gas supply means. However, the carrier gas supply means is not limited thereto, and may be blowing means such as an air pump, a blower or the like, or a substance that generates a gas upon heating.

When using concomitantly solid-state methanol and a water-containing solid material, moreover, it is not necessary to mix the solid-state methanol and the water-containing solid material in the fuel cartridge 3, as in the above embodiments. A cartridge storing a water-containing solid material (water-replenishment container), and separate from the fuel cartridge 3 storing solid-state methanol, may be provided between the fuel cartridge 3 and the fuel cell 5, i.e. in the fuel gas flow path 4.

In the second embodiment or the fifth embodiment, the air pump 10A or 10B, or the air pump 20A, 20B or 20C, is controlled by a controller on the basis of the output value of an output sensor. However, the pumps may be operated without undergoing such a control, for instance by intermittently supplying a predetermined amount of air at predetermined intervals, or by supplying small amounts of air continuously or discontinuously.

In the third embodiment and the sixth embodiment, for instance the film-coated solid-state methanol S need not be 100% pure methanol in a solid-state form. The solid-state methanol may be obtained by adding water to methanol, to yield a methanol solution of a desired concentration that is then made into a solid state. With the film-coated solid-state methanol there can also be concomitantly used water having been made into a solid state (film-coated solid-state water) in accordance with a similar method.

The direct methanol fuel cell system according to the present invention as described above, having no liquid inside the system, can thus be made compact and free of drops in output and the like so long as the solid-state methanol has a predetermined amount of methanol. The direct methanol fuel cell system of the present invention is therefore particularly suitable as a power source for portable electronic devices.

### EXAMPLES

The present invention is explained in more detail based on the examples below. Unless departing from the scope thereof, the present invention is not meant in any way to be limited to or by the following examples.

### Example 1

### [Fuel Cell]

The specifications of the fuel cell used for testing were as follows.
MEA: MEA for DMFCs by Chemix Inc.
   Electrolyte membrane: Nafion 117 (by DuPont, membrane thickness 50 μm)
   Anode (fuel electrode) catalyst: Pt—Ru/C
   Cathode (air electrode) catalyst: Pt/C
   Effective membrane area: 40×40 mm
Collector material: SUS mesh (Au-plated)
Fuel electrode: sealed structure
Air electrode: open structure

### [Preparation of Film-coated Solid-state Methanol]

Solid-state methanol particles were obtained by blending hydroxypropyl cellulose (2 g) and methanol (300 g) with magnesium aluminometasilicate (100 g) and by granulating the blend, using a granulator, into spherical particles having a diameter of about 3 mm.

To prepare film-coated solid-state methanol particles, the solid-state methanol particles were charged into a coating apparatus, and were dried therein through blowing of a 0.5% methanol aqueous solution of ethyl cellulose for 5 minutes at a flow rate of 10 mL/min, to form thereby an ethyl cellulose coating, about 30 μm thick, on the solid-state methanol particles. The methanol content of the film-coated solid-state methanol particles was about 65%.

### [Direct Methanol Fuel Cell System]

To manufacture the system, the cartridge 3 illustrated in FIG. 2, having 40×40×10 dimensions (mm), was packed with 5 g of the film-coated solid-state methanol particles, and then the cartridge 3 was mounted on the system illustrated in FIG. 7. The fuel electrode 6 of the fuel cell 5 that was used had been moistened beforehand through soaking with pure water. The pure water was drained before the test and the water droplets were removed under a nitrogen gas stream. The flow rate of N₂ gas, as the carrier gas, was 80 mL/min. The separator 11 of the fuel electrode 6 had the shape illustrated in FIG. 3.

### Example 2

A direct methanol fuel cell system (Example 2) was manufactured in the same way as in Example 1, but herein the film-coated solid-state methanol was prepared using a methanol aqueous solution (concentration 70wt %), to a methanol content of 40% and a water content of 20%.

### Example 3

A direct methanol fuel cell system (Example 3) was manufactured in the same way as in Example 1, but herein the fuel cartridge 3 was packed with 3 g of the film-coated solid-state methanol plus 2 g of a water-containing solid material (water-containing neusilin, water content 75%) prepared in the similar way as the film-coated solid-state methanol.

### Example 4

A direct methanol fuel cell system (Example 4) was manufactured in the same way as in Example 1, but using the separator illustrated in FIG. 4 as the separator 11 of the fuel electrode 6 of the fuel cell 5.

### Example 5

A direct methanol fuel cell system (Example 5) was manufactured in the same way as in Example 1, but using the separator illustrated in FIG. 5 as the separator 11 of the fuel electrode 6 of the fuel cell 5.

### Example 6

### [Direct Methanol Fuel Cell System]

To manufacture a system, the cartridge 3 illustrated in FIG. 2, having 40×40×10 dimensions (mm), was packed with 5 g of film-coated solid-state methanol particles manufactured in the same way as in Example 1, and then the cartridge 3 was mounted on the system illustrated in FIG. 8. The fuel cell used was identical to that of Example 1. The fuel electrode 6 of the fuel cell 5 that was used had been moistened beforehand through soaking with pure water. The pure water was drained before the test and the water droplets were removed under a nitrogen gas stream. The flow rate of N₂ gas, as the carrier gas, was 80 mL/min. An air pump supplied 20 mL of air every 4 minutes via the fuel gas flow path 4.

### Example 7

### [Direct Methanol Fuel Cell System]

To manufacture a system, the cartridge 3 illustrated in FIG. 2, having 40×40×10 dimensions (mm), was packed with 5 g of film-coated solid-state methanol particles manufactured in the same way as in Example 1, and then the cartridge 3 was mounted on the system illustrated in FIG. 7. The fuel cell used was identical to that of Example 1. The fuel electrode 6 of the fuel cell 5 that was used had been moistened beforehand through soaking with pure water. The pure water was drained before the test and the water droplets were removed under a nitrogen gas stream.

### Example 8

### [Direct Methanol Fuel Cell System]

To manufacture a system, the cartridge 3 illustrated in FIG. 2, having 40×40×10 dimensions (mm), was packed with 5 g of film-coated solid-state methanol particles manufactured in the same way as in Example 1, and then the cartridge 3 was mounted on the system illustrated in FIG. 1. The fuel cell used was identical to that of Example 1. The fuel electrode 16 of the fuel cell 15 that was used had been moistened beforehand through soaking with pure water. The pure water was drained before the test and the water droplets were removed under a nitrogen gas stream. The flow rate of N₂ gas, as the carrier gas, was 80 mL/min. The separator 11 of the fuel electrode 16 had the shape illustrated in FIG. 3.

### Example 9

A direct methanol fuel cell system (Example 9) was manufactured in the same way as in Example 8, but herein the film-coated solid-state methanol was prepared using a methanol aqueous solution (concentration 70 wt %), to a methanol content of 40% and a water content of 20%.

### Example 10

A direct methanol fuel cell system (Example 10) was manufactured in the same way as in Example 8, but herein the fuel cartridge 3 was packed with 3 g of the film-coated solid-state methanol plus 2 g of a water-containing solid material (water-containing neusilin, water content 75%) prepared in the similar way as the solid-state methanol.

### Example 11

A direct methanol fuel cell system (Example 11) was manufactured in the same way as in Example 8, but using the separator illustrated in FIG. 4 as the separator 11 of the fuel electrode 16 of the fuel cell 15.

### Example 12

A direct methanol fuel cell system (Example 12) was manufactured in the same way as in Example 8, but using the separator illustrated in FIG. 5 as the separator 11 of the fuel electrode 16 of the fuel cell 15.

### Example 13

To manufacture a system, the cartridge 3 illustrated in FIG. 2, having 40×40×10 dimensions (mm), was packed with 5 g of film-coated solid-state methanol manufactured in the same way as in Example 1, and then the cartridge 3 was mounted on the system illustrated in FIG. 6. The fuel cell used was identical to that of Example 1. The fuel electrode 16 of the fuel cell 15 that was used had been moistened beforehand through soaking with pure water. The pure water was drained before the test and the water droplets were removed under a nitrogen gas stream. Air, as the gas carrier, was circulated at a flow rate of 80 mL/min. An air pump supplied 20 mL of air every 4 minutes via the fuel gas flow path 14.

### Example 14

To manufacture a system, the cartridge 3 illustrated in FIG. 2, having 40×40×10 dimensions (mm), was packed with 5 g of film-coated solid-state methanol manufactured in the same way as in Example 1, and then the cartridge 3 was mounted on the system illustrated in FIG. 1. The fuel cell used was identical to that of Example 1. The fuel electrode 16 of the fuel cell 15 that was used had been moistened beforehand through soaking with pure water. The pure water was drained before the test and the water droplets were removed under a nitrogen gas stream.

### Comparative Example 1

A direct methanol fuel cell system (Comparative example 1) was manufactured in the similar way as in Example 1, except that herein a 3% methanol aqueous solution was supplied to the fuel electrode 6 of the fuel cell 5, without using a carrier gas.

### Comparative Example 2

A direct methanol fuel cell system (Comparative example 2) was manufactured in the similar way as in Example 6, except that herein a 3% methanol aqueous solution was supplied to the fuel electrode 6 of the fuel cell 5, without using a carrier gas.

### Comparative Example 3

A direct methanol fuel cell system (Comparative example 3) was manufactured in the similar way as in Example 7, except that herein a 3% methanol aqueous solution was supplied to the fuel electrode 6 of the fuel cell 5.

### Comparative Example 4

A direct methanol fuel cell system (Comparative example 4) was manufactured in the similar way as in Example 8, except that herein a 3% methanol aqueous solution was supplied to the fuel electrode 16 of the fuel cell 15, without using a carrier gas.

### Reference Example 1

A direct methanol fuel cell system (Reference example 1) was manufactured in the similar way as in Example 6, but without providing a pump and thus with no air mixed in.

### Reference Example 2

A direct methanol fuel cell system (Reference example 2) was manufactured in the same way as in Example 7, except that the cartridge 3 was packed with the solid-state methanol particles on which were not formed coating film.

### [Power Generation Test]

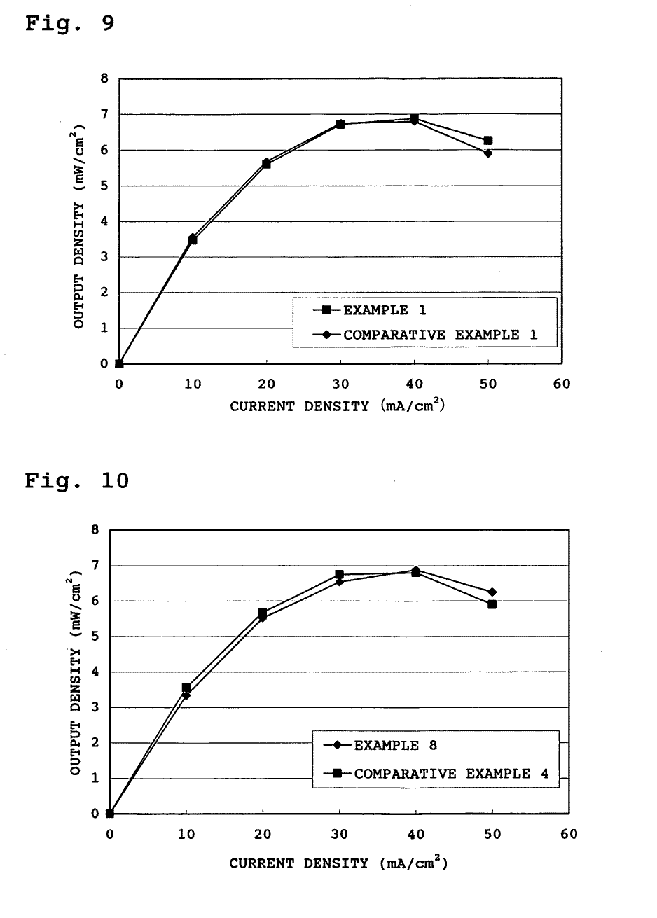

Using an electronic load device, current was made to flow through the direct methanol fuel cell systems of Examples 1 to 14, Comparative examples 1 to 4 and Reference examples 1 to 2, to measure fuel cell characteristics. FIG. 9 shows graphs for Example 1 and Comparative example 1, in which the horizontal axis represents load current density (mA/cm², value resulting from dividing load current by the effective membrane area of the MEA), and the virtical axis represents the output density of the cell (mW/cm², product of the load current density by the voltage value (V) between the fuel electrode and the air electrode).

As FIG. 9 shows, in the direct methanol fuel cell system of Example 1 cell voltage was stable during measurement, and maximum output was about 7 mW/cm². Moreover, there was virtually no drop in output after 2 hours of operation in that state.

In the direct methanol fuel cell system of Comparative example 1, where a methanol aqueous solution was supplied, cell voltage was stable during measurement but the maximum output was lower, of about 6.5 mW/cm², and there was observed a drop in output after 1 hour of operation in that state. This is believed to arise from a decrease in reactivity at the fuel electrode 6 caused by carbon dioxide gas.

The same power generation test of Example 1 was conducted in the direct methanol fuel cell system of Example 2. The measurements of the fuel cell characteristics revealed a better stability over time than in Example 1, on account, presumably, of the simultaneous supply of methanol and water to the fuel electrode 6.

The same power generation test of Example 1 was conducted in the direct methanol fuel cell system of Example 3. The measurements of the fuel cell characteristics revealed a better stability over time than in Example 1, on account, presumably, of the simultaneous supply of methanol and water to the fuel electrode 6.

The same power generation test of Example 1 was conducted in the direct methanol fuel cell system of Example 4. The measurements of the fuel cell characteristics showed that output took a longer time to drop than in Example 1. This is believed to result from improved Nernst loss.

The same power generation test of Example 1 was conducted in the direct methanol fuel cell system of Example 5. The measurements of the fuel cell characteristics showed that output took a longer time to drop than in Example 1. This is believed to result from improved Nernst loss.

In the direct methanol fuel cell system of Example 6 cell voltage was stable during measurement, and maximum output was about 16 mW/cm². Moreover, there was virtually no drop in output after 2 hours of operation in that state.

In the direct methanol fuel cell system of Comparative example 2, where a methanol aqueous solution was supplied, cell voltage was stable during measurement but the maximum output was low, of about 14 mW/cm², and there was observed a drop in output after 1 hour of operation in that state. This is believed to arise from a decrease in reactivity at the fuel electrode 6 caused by carbon dioxide gas.

In the direct methanol fuel cell system of Reference example 1, where air was not supplied periodically, cell voltage was stable during measurement, and maximum output was about 16 mW/cm². However, output was observed to drop after 1 hour of operation in that state. Water insufficiency is thought to contribute to this result.

The same power generation test of Example 6 was conducted in the direct methanol fuel cell system of Example 13. The measurements of the fuel cell characteristics yielded similar results to those of Example 6.

Using an electronic load device, current was made to flow through the direct methanol fuel cell systems of Example 7, Example 14, Comparative example 3 and Reference example 2, to measure fuel cell characteristics, namely cell voltage (V) at maximum output, load current density (mA/cm²) at maximum output, maximum output (mW/cm²) and fuel cell temperature (° C.). The results are shown in Table 1.

TABLE 1

| | Cell voltage | Load current | Maximum | Fuel cell |
|---|---|---|---|---|
| | at maximum | density at maximum | output | temperature |
| | output (V) | output (mA/cm²) | (mW/cm²) | (° C.) |
| Example 7 | 0.249 | 70 | 17.43 | 34.6 |
| Example | 0.259 | 70 | 18.13 | 34.9 |
| 14 | | | | |
| Ref. | 0.235 | 50 | 11.75 | 44.6 |
| example 2 | | | | |
| Comp. | 0.231 | 60 | 13.86 | 29.9 |
| example 3 | | | | |

As Table 1 shows, the fuel cell system of Example 7 exhibited a maximum output of 17.43 mW/cm² and a fuel cell temperature of 34.6° C., and the fuel cell system of Example 14 exhibited a maximum output of 18.13 mW/cm² and a fuel cell temperature of 34.9° C. The fuel cell system of Reference example 2 exhibited a maximum output of 11.75 mW/cm², but a high fuel cell temperature, of 44.6° C. Crossover of methanol, arising from the supply of high-concentration methanol vapor, is thought to be behind this heat generation in the fuel cell, since the crossover methanol undergoes an exothermic oxidation reaction in the air electrode.

The fuel cell system of Comparative example 3 exhibited a maximum output of 13.86 mW/cm² and a fuel cell temperature of 29.9° C. The differences in maximum output between the examples and Comparative example 3 are believed to stem from the fact that methanol was supplied as a gas in the fuel cell systems of all the examples.

FIG. 10 shows graphs for Example 8 and Comparative example 4, in which the horizontal axis represents load current density (mA/cm², value resulting from dividing load current by the effective membrane area of the MEA), and the vertical axis represents the output density of the cell (mW/cm², product of the load current density by the voltage value (V) between the fuel electrode and the air electrode).

As FIG. 10 shows, in the direct methanol fuel cell system of Example 8 cell voltage was stable during measurement, and maximum output was about 7 mW/cm². Moreover, there was virtually no drop in output upon 2 hours of operation in that state, under circulation of the carrier gas.

In the direct methanol fuel cell system of Comparative example 4, where a methanol aqueous solution was supplied, cell voltage was stable during measurement but maximum output was low, of about 6.5 mW/cm², and there was observed a drop in output after 1 hour of operation in that state. This is believed to arise from a decrease in reactivity at the fuel electrode 16 caused by carbon dioxide gas.

The same power generation test of Example 8 was conducted in the direct methanol fuel cell system of Example 9. The measurements of the fuel cell characteristics revealed a better stability over time than in Example 8, presumably thanks to the simultaneous supply of methanol and water to the fuel electrode 16.

The same power generation test of Example 8 was conducted in the direct methanol fuel cell system of Example 10. The measurements of the fuel cell characteristics revealed a better stability over time than in Example 8, presumably thanks to the simultaneous supply of methanol and water to the fuel electrode 16.

The same power generation test of Example 8 was conducted in the direct methanol fuel cell system of Example 11. The measurements of the fuel cell characteristics showed that output took a longer time to drop than in Example 8. This is believed to result from improved Nernst loss.

The same power generation test of Example 8 was conducted in the direct methanol fuel cell system of Example 12. The measurements of the fuel cell characteristics showed that output took a longer time to drop than in Example 8. This is believed to result from improved Nernst loss.

1. A direct methanol fuel cell system, comprising:
a fuel storage portion that stores solid-state methanol resulting from making methanol into a solid state;
a fuel cell; and
carrier gas circulation means,
wherein said fuel storage portion is provided with a carrier gas supply path communicating with said carrier gas circulation means and a fuel gas flow path communicating with a fuel electrode side of said fuel cell,
said fuel cell is provided with a circulation flow path communicating with said fuel electrode side and communicating with said carrier gas circulation means, and
when a carrier gas is supplied by said carrier gas circulation means into said fuel storage portion via said carrier gas supply path, a fuel gas comprising methanol vaporized from said solid-state methanol is supplied to a fuel electrode of said fuel cell and is refluxed thereafter towards said carrier gas circulation means through said circulation flow path.

2. The direct methanol fuel cell system according to claim 1, wherein controllable air introduction means is provided in said carrier gas supply path, said fuel gas flow path or said circulation flow path.

3. The direct methanol fuel cell system according to claim 1, wherein a film is formed on the surface of said solid-state methanol.

4. A direct methanol fuel cell system, comprising:
a fuel storage portion that stores solid-state methanol resulting from making methanol into a solid state;
a fuel cell; and
carrier gas supply means,
wherein said fuel storage portion is provided with a carrier gas supply path communicating with said carrier gas supply means and a fuel gas flow path communicating with a fuel electrode side of said fuel cell,
said fuel cell is provided with an exhaust gas path communicating with said fuel electrode side, and
when a carrier gas is supplied to said fuel storage portion, a fuel gas comprising methanol vaporized from said solid-state methanol is supplied to a fuel electrode of said fuel cell, and is discharged thereafter through said exhaust gas path.

5. A direct methanol fuel cell system, comprising:
a fuel storage portion that stores solid-state methanol resulting from making methanol into a solid state;
a fuel cell; and
fuel gas supply means for supplying, to said fuel cell, a fuel gas comprising methanol vaporized from said solid-state methanol as a result of flow of a carrier gas,
wherein said fuel gas supply means is provided with controllable air introduction means.

6. The direct methanol fuel cell system according to claim 5,
wherein said fuel gas supply means comprises carrier gas supply means; a carrier gas supply path, provided in said fuel storage portion and communicating with said carrier gas supply means; and a fuel gas flow path communicating with a fuel electrode side of said fuel cell,
said fuel cell is provided with an exhaust gas path communicating with said fuel electrode side,
said controllable air introduction means is provided in said carrier gas supply path or said fuel gas flow path, and
when a carrier gas is supplied to said fuel storage portion, a fuel gas comprising methanol vaporized from said solid-state methanol is supplied to a fuel electrode of said fuel cell, and is discharged thereafter through said exhaust gas path.

7. A direct methanol fuel cell system, comprising:
a fuel storage portion that stores solid-state methanol resulting from making methanol into a solid state;
a fuel cell; and
fuel gas supply means for supplying, to said fuel cell, a fuel gas comprising methanol vaporized from said solid-state methanol as a result of flow of a carrier gas,
wherein a film is formed on the surface of said solid-state methanol.

8. The direct methanol fuel cell system according to claim 7,
wherein said fuel storage portion is provided with a carrier gas supply path communicating with said carrier gas supply means and a fuel gas flow path communicating with a fuel electrode side of said fuel cell,
said fuel cell is provided with an exhaust gas path communicating with said fuel electrode side, and
when a carrier gas is supplied to said fuel storage portion, a fuel gas comprising methanol vaporized from said solid-state methanol having a film formed thereon is supplied to a fuel electrode of said fuel cell, and is discharged thereafter through said exhaust gas path.

9. The direct methanol fuel cell system according to claim 4, wherein said carrier gas supply means is blowing means.

10. The direct methanol fuel cell system according to claim 4, wherein said carrier gas supply means is a compressed gas cylinder.

11. The direct methanol fuel cell system according to claim 4, wherein said carrier gas supply means has a heating device and a substance that generates a gas when heated.

12. The direct methanol fuel cell system according to claim 1, wherein said fuel storage portion is a detachable cartridge.

13. The direct methanol fuel cell system according to claim 1, wherein the carrier gas that is supplied to the fuel electrode of said fuel cell comprises substantially no oxygen.

14. The direct methanol fuel cell system according to claim 1, wherein said solid-state methanol is obtained by turning a methanol aqueous solution into a solid state.

15. The direct methanol fuel cell system according to claim 1, wherein said fuel storage portion contains said solid-state methanol and a water-containing solid material.

16. The direct methanol fuel cell system according to claim 1, wherein a water-replenishment container containing a water-containing solid material is provided between said fuel storage portion and said fuel cell.

17. The direct methanol fuel cell system according to claim 1, wherein said fuel gas flow path has a branched shape in said fuel electrode.

18. A portable electronic device, comprising the direct methanol fuel cell system according to claim 1.
